(19) United States
(12) Patent Application Publication
(10) Pub. No.: US 2025/0276267 A1
(43) Pub. Date: Sep. 4, 2025

(54) Adsorption System and Process for Biofuel Precursor and Adsorbent Material for the Same

(71) Applicant: Georgia Tech Research Corporation, Atlanta, GA (US)

(72) Inventors: Matthew Realff, Atlanta, GA (US); Qiang Fu, Atlanta, GA (US); Yadong Chiang, Atlanta, GA (US); Sankar Nair, Atlanta, GA (US)

(21) Appl. No.: 19/068,859

(22) Filed: Mar. 3, 2025

Related U.S. Application Data
(60) Provisional application No. 63/560,096, filed on Mar. 1, 2024.

(51) Int. Cl. B01D 53/04; B01J 20/28

(52) U.S. Cl. CPC B01D 53/04; B01J 20/28004; B01D 2253/108; B01D 2258/05

(57) ABSTRACT

Disclosed herein are adsorption systems and processes and adsorbent materials used therein. The disclosed systems comprise a feed line configured to provide a feed stream comprising a biofuel precursor, a biomass byproduct, and water; a first sorbent bed attached to the feed line; a second sorbent bed attached to the feed line; a raffinate line attached to both the first sorbent bed and the second sorbent bed, the raffinate stream comprising the biomass byproduct and water, and an extract line attached to both the first sorbent bed and the second sorbent bed, the extract stream comprising the biofuel precursor.

### CROSS REFERENCE TO RELATED APPLICATIONS

This application claims the benefit of U.S. Provisional Application Ser. No. 63/560,096, filed on 1 Mar. 2024, the entire contents and substance of which is incorporated herein by reference in its entirety as if fully set forth below.

### STATEMENT OF RIGHTS UNDER FEDERALLY SPONSORED RESEARCH

This invention was made with government support under DE-AC05-00OR22725 awarded by the Department of Energy. The government has certain rights in the invention.

### FIELD OF THE DISCLOSURE

The present disclosure relates generally to adsorption systems and processes for a biofuel precursor and an adsorbent material for the same. Particularly, the present disclosure relates to separation of a biofuel precursor from a fermentation broth via adsorption over zeolites.

### BACKGROUND

There are many chemicals which act as important building blocks and precursors that have wide applications in the production of sustainable fuels, synthetic rubber, added-value chemicals, additives, and polymers. One example of such a chemical is 2,3-butanediol (BDO). The petroleum- based route to BDO is via chlorohydrination and hydrolysis of a C4 mixture obtained from cracking gases. More recently, however, biomass-derived BDO production has gained great interest of the production of biojet fuels via catalytic dehydration to C4 olefins followed by oligomerization reactions. The current dramatic increase of concerns on climate change and instability of fossil fuel prices have motivated the shift of BDO production from petroleum-based processes toward biology-based routes.

In most biological routes, BDO is produced by mixed-acid fermentation with bacterial cells. The process results in the release of acidic compounds, and the butanediol cycle is then initiated to prevent excessive acidification. Zymomonas mobilis is well-known for its high specific glucose uptake rate and rapid catabolismhe anaerobic production of BDO in Z. mobilis from C6/C5 sugar streams derived from the deacetylation and mechanical refining process has been demonstrated previously. While the resulting concentration of BDO from microbial production routes, such as those using Klebsiella pneumoniae, can be as high as approximately 150 g/L, the recovery of BDO is complicated by the presence of unreacted sugar feedstock, solid/dissolved debris, and fermentation byproducts. The separation of BDO and water is additionally difficult due to its high boiling point and affinity for water. In the upgrading path toward biojet fuels, regulation of water content is especially of importance to enhance the conversions and selectivity toward olefins. The broth characteristics lead to uneconomical results when conventional separations such as distillation are employed.

Several alternative separation technologies have been proposed, including liquid-liquid extraction, membrane distillation or pervaporation, and reactive extraction. However, membranes are subject to fouling and have difficulty scaling while preferentially permeating BDO over water and other species. Liquid-liquid extraction and distillation require significant energy for separation. And, reactive extraction's scalability is challenged by its suboptimal recovery, the difficulty of recycling acid catalysts, and equipment corrosion.

What is needed, therefore, is an improved technique for BDO separation with good selectivity, mass transfer characteristics, as well as excellent chemical stability in the fermentation broth and the desorbent. The present disclosure addresses this need as well as other needs as will become apparent upon reading the present disclosure.

### BRIEF SUMMARY

An embodiment of the present disclosure provides an adsorption system comprising a feed line configured to provide a feed stream comprising a biofuel precursor in an amount from 5% to 15% by weight based on the total weight of the feed stream, a biomass byproduct, and water; a first sorbent bed attached to the feed line, the first sorbent bed configured to adsorb the biofuel precursor; a second sorbent bed attached to the feed line, the second sorbent bed configured to adsorb the biofuel precursor; a raffinate line attached to both the first sorbent bed and the second sorbent bed, the raffinate line receiving a raffinate stream from the first sorbent bed and the second sorbent bed, the raffinate stream comprising the biomass byproduct and water; and an extract line attached to both the first sorbent bed and the second sorbent bed, the extract line receiving an extract stream from the first sorbent bed and the second sorbent bed, the extract stream comprising the biofuel precursor.

In any of the embodiments disclosed herein, the biofuel precursor can comprise 2,3-butanediol.

In any of the embodiments disclosed herein, the biomass byproduct can comprise one or more of: a sugar feedstock provided for a fermentation process of the biofuel precursor, a fermentation byproduct produced by the fermentation process of the biofuel precursor, and solid debris from the fermentation process of the biofuel precursor.

In any of the embodiments disclosed herein, the sorbent bed can comprise a zeolite.

In any of the embodiments disclosed herein, the zeolite can comprise the zeolite ZSM-5 (MFI).

In any of the embodiments disclosed herein, the zeolite can comprise solid crystals having a size from 200 nm to 250 nm.

In any of the embodiments disclosed herein, the zeolite can have an uptake from 80 g of biofuel precursor/kg of zeolite to 95 g of biofuel precursor/kg of zeolite.

In any of the embodiments disclosed herein, the zeolite can have a biofuel precursor/water selectivity from 10 to 25.

Another embodiment of the present disclosure provides an adsorption process comprising receiving a feed stream comprising a biofuel precursor in an amount from 5% to 15% by weight based on the total weight of the feed stream, a biomass byproduct, and water; adsorbing, into a sorbent bed, the biofuel precursor, to form a raffinate stream comprising the biomass byproduct and water; and desorbing the biofuel precursor from the sorbent bed to form an extract stream comprising the biofuel precursor.

In any of the embodiments disclosed herein, the biofuel precursor can comprise 2,3-butanediol.

In any of the embodiments disclosed herein, the biomass byproduct can comprise one or more of: a sugar feedstock provided for a fermentation process of the biofuel precursor, a fermentation byproduct produced by the fermentation process of the biofuel precursor, and solid debris from the fermentation process of the biofuel precursor.

In any of the embodiments disclosed herein, the sorbent bed can comprise a zeolite.

In any of the embodiments disclosed herein, the zeolite can comprise the zeolite ZSM-5 (MFI).

In any of the embodiments disclosed herein, the zeolite can comprise solid crystals having a size from 200 nm to 250 nm.

In any of the embodiments disclosed herein, the zeolite can have an uptake from 80 g of biofuel precursor/kg of zeolite to 95 g of biofuel precursor/kg of zeolite.

In any of the embodiments disclosed herein, the zeolite can have a biofuel precursor/water selectivity from 10 to 25.

In any of the embodiments disclosed herein, the sorbent bed can be a first sorbent bed, and the adsorption process can further comprise: simultaneously desorbing the biofuel precursor from a second sorbent bed concurrently with the adsorbing the biofuel precursor into the first sorbent bed, the biofuel precursor from the second sorbent bed being transferred to extract stream; and simultaneously adsorbing the biofuel precursor into the second sorbent bed concurrently with the desorbing the biofuel precursor from the first sorbent bed.

Another embodiment of the present disclosure provides an adsorbent material comprising a zeolite comprising solid crystals having a size from 200 nm to 250 nm, the zeolite having: (i) an uptake from 80 g of a biofuel precursor/kg of zeolite to 95 g of biofuel precursor/kg of zeolite; and (ii) a biofuel precursor/water selectivity from 10 to 25.

In any of the embodiments disclosed herein, the biofuel precursor can comprise 2,3-butanediol.

In any of the embodiments disclosed herein, the zeolite can comprise the zeolite ZSM-5 (MFI).

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 is a schematic diagram of a biofuel manufacturing process in accordance with the present disclosure.

FIG. 2 is a schematic diagram of an adsorption system in accordance with the present disclosure.

FIG. 3 is a flowchart illustrating an adsorption method in accordance with the present disclosure.

FIG. 4A is a schematic diagram of an adsorption unit having two or more sorbent beds in accordance with the present disclosure.

FIG. 4B is a schematic diagram of another adsorption unit having two or more sorbent beds in accordance with the present disclosure.

FIGS. 5A and 5B are charts showing multicomponent breakthrough experiments for an adsorbent material in accordance with the present disclosure.

FIGS. 6A and 6B are charts showing multicomponent breakthrough experiments for an adsorbent material in accordance with the present disclosure.

FIG. 7 illustrates the cyclic operation of an adsorption system in accordance with the present disclosure.

FIGS. 8A-D are charts showing uptakes and selectivity for examples of adsorbent materials in accordance with the present disclosure.

### DETAILED DESCRIPTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Selective adsorption has been proposed in other fermentation systems. Recovery of the adsorbed product is achieved either by temperature cycling (if the product is volatile enough) or more commonly by a liquid desorbent that is then recycled by a distillation column. Depending on the desorbent-to-feed ratio and the case of desorbent recycling, adsorption processes can lower the costs of biorefinery separations. It is understood in the present disclosure that hydrophobic nanoporous materials with appropriate pore sizes would absorb BDO, whereas sugars and other polyols would be rejected. Nanoporous metal-organic frameworks (MOFs), such as zeolitic imidazolate frameworks, could adsorb BDO from fermentation broth with high selectivity over the other components, including organics, inorganics, and water. However, some MOFs can lose their framework integrity, thereby leading to a drastic decrease of BDO uptake and selectivity due to the breakage of the metal-organic linker coordination bond. Further, other MOFs have behavior indicating the presence of significant mass transfer limitation sowing to small pore size.

To overcome such issues, the present disclosure provides a medium-pore, hydrophobic, and more chemically robust material, such as a zeolite, which can provide good BDO adsorption selectivity, mass transfer (diffusion) characteristics, as well as excellent chemical stability in the fermentation broth and the desorbent. One example of such a material is ZSM-5 (MFI) zeolite. MFI is amenable to bulk synthesis, and its hydrophobicity can be controlled by adjusting the Si/Al ratio for which a pure SiO₂ MFI would be preferable in some cases. Furthermore, to achieve favorable diffusion characteristics, the presently disclosed MFI materials can have nanosize (e.g., 300 nm size or less).

The present disclosure also provides for recovery and purification of BDO in an adsorption process and system utilizing such materials. The disclosed separation system and process results in large energy savings by removing the massive parasitic cost/deadload of aqueous-phase BDO upgrading.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

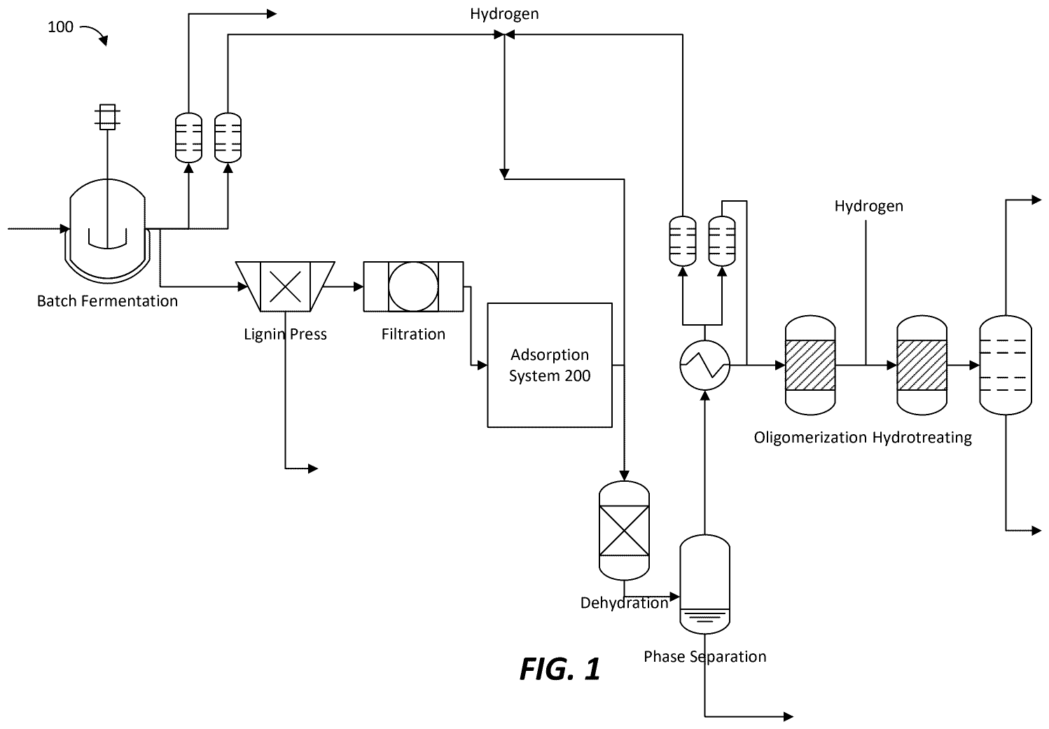

FIG. 1 is a schematic diagram of a biofuel manufacturing process 100. As shown, the biofuel manufacturing process 100 utilizes the adsorption system 200 of the present disclosure, which will be described in greater detail below. Due to the clean separation of organics from water by the adsorption system 200 of the present disclosure, there is no concern regarding catalyst degradation downstream in the biofuel manufacturing process 100. In such a manner, other separation processes needed in traditional biofuel manufacturing processes, such as an ion exchanger, can be removed. Additionally, the dehydration reactor shown in FIG. 1 can be vastly reduced in size since there is no water deadload, and the downstream distillation column can be replaced with a simple phase separation tank to remove residual water from the hydrocarbons remaining.

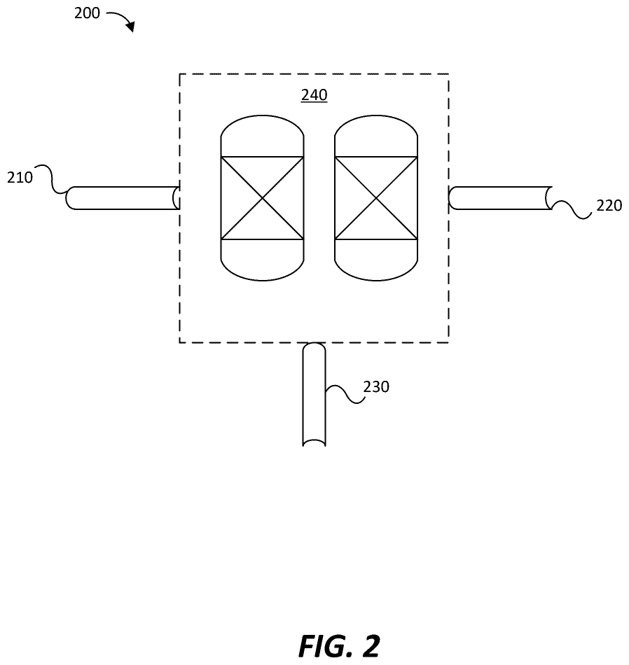

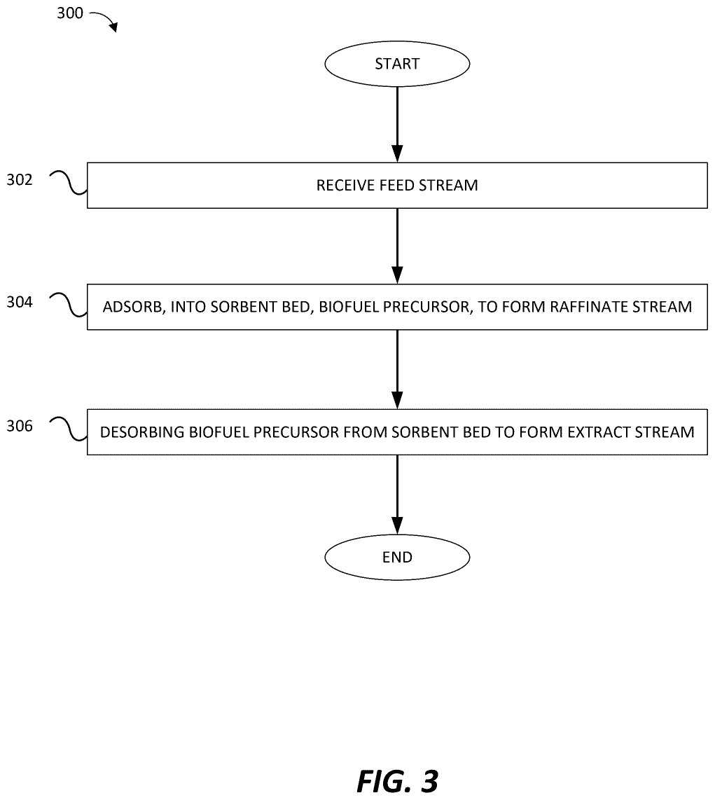

FIG. 2 is a schematic diagram of the adsorption system 200 of the present disclosure. The adsorption system 200 comprises a feed line 210, a raffinate line 220, and an extract line 230. The adsorption system 200 further comprises an adsorption unit 240, which comprises a first sorbent bed and a second sorbent bed. The adsorption unit 240 can comprise more than two sorbent beds; however, it is noted that the adsorption unit 240 comprises at least two sorbent beds. The adsorption unit 240 is described in greater detail below in FIG. 3

The feed line 210 is configured to provide a feed stream to the adsorption unit 240. The feed stream comprises a biofuel precursor, a biomass byproduct, and water. The biofuel precursor is present in the feed stream in an amount from 5% to 15% by weight (e.g. from 6% to 15%, from 7% to 15%, from 8% to 15%, from 9% to 15%, from 10% to 15%, from 10% to 14%, from 10% to 13%, from 10% to 12%, from 5% to 12%, from 5% to 11%, or from 5% to 10%), based on the total weight of the feed stream.

As would be appreciated, the feed line can be received from a fermentation process in which biomass is fermented. As such, the fermentation process produces the biomass byproduct. The biomass byproduct can include, for instance, a sugar feedstock provided for a fermentation process of the biofuel precursor, a fermentation byproduct produced by the fermentation process of the biofuel precursor, and solid debris from the fermentation process of the biofuel precursor. The water in the feed line is also a result of the fermentation process and can provide an aqueous solution with which to carry the biofuel precursor.

The biofuel precursor is produced by the fermentation process and is then provided to the feed line. One example of such a biofuel precursor is 2,3-butanediol.

The raffinate line 220 is attached to the adsorption unit 240 and receives a raffinate stream from the sorbent beds in the adsorption unit 240. The raffinate stream comprises the biomass byproduct and water. The extract line 230 is also attached to the adsorption unit 240 and receives an extract stream from the sorbent beds in the adsorption unit 240. The extract stream comprises the biofuel precursor.

The extract stream can have a biofuel precursor recovery of 90% or greater (e.g., 91% or greater, 92% or greater, 93% or greater, 94% or greater, 95% or greater, 96% or greater, 97% or greater, 98% or greater, or 99% or greater). In other words, the extract stream can retain 90% or greater of the biofuel precursor present in the feed stream. The extract stream can also have a biofuel precursor purity of 95% or greater (e.g., 96% or greater, 97% or greater, 98% or greater, or 99% or greater). In other words, no other component beside the biofuel precursor is present in the extract stream in an amount of 5% or less (e.g., 4% or less, 3% or less, 2% or less, or 1% or less).

FIG. 3 illustrates a flowchart of an adsorption process 300. The adsorption process is described herein as being carried out by the adsorption system 200, but it is understood that the adsorption process 300 can be performed by any system capable of performing the presently disclosed method steps.

The method 300 comprises receiving 302 the feed stream comprising the biofuel precursor, the biomass byproduct, and water. The contents of the feed stream are described in further detail above with respect to the feed line 210.

The method 300 further comprises adsorbing 304 the biofuel precursor into a sorbent bed, such as those within the adsorption unit 240. As would be appreciated, the sorbent bed can have such material properties and sorbent characteristics that it can adsorb the biofuel precursor while rejecting the other components from the feed stream. The rejected components can then be removed from the adsorption unit in the raffinate stream.

The method 300 then further comprises desorbing 306 the biofuel precursor from the sorbent bed. The desorbed biofuel precursor then enters the extract stream and is removed from the adsorption unit 240. In such a manner, the biofuel precursor is effectively recovered from the feed stream and concentrated in the extract stream.

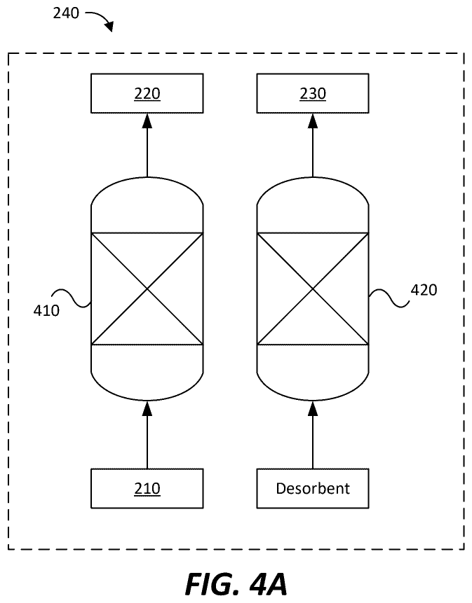

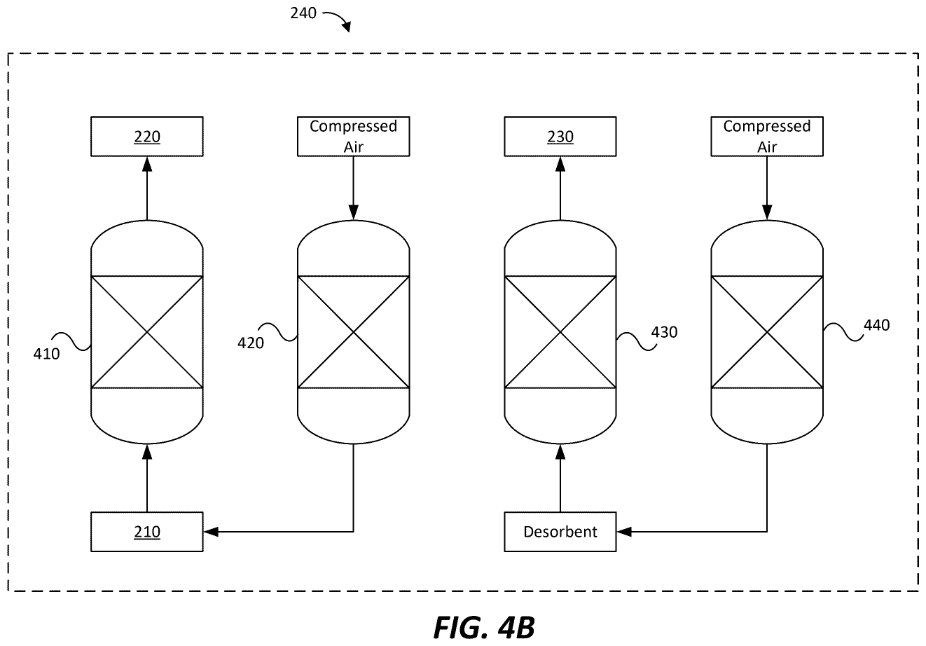

FIG. 4A illustrates one potential arrangement of the adsorption unit 240. As shown, the adsorption unit 240 can comprise a first sorbent bed 410 and a second sorbent bed 420. While the first sorbent bed 410 is adsorbing the biofuel precursor, the second sorbent bed 420 can be simultaneously desorbing the biofuel precursor that was previously adsorbed in the second sorbent bed 420. Then, when the first sorbent bed 410 is desorbing the biofuel precursor, the second sorbent bed 420 can be simultaneously adsorbing additional biofuel precursor from the feed stream. In such a manner, the first sorbent bed 410 and the second sorbent bed 420 can operate concurrently such that the adsorption unit 240 operates continuously.

Further, as shown in FIG. 4B, the adsorption unit 240 can comprise two or more sorbent beds. For example, the adsorption unit 240 can further comprise a third sorbent bed 430 and a fourth sorbent bed 440. In such a manner, between transitioning from adsorbing and desorbing the biofuel precursor, the sorbent beds can be purged with compressed air to remove interstitial fluid held in external voids in the sorbent material.

Further, in such an arrangement with a third sorbent bed 430 and a fourth sorbent bed 440, the adsorption unit 240 can also include a purge with compressed air. As would be appreciated, the purge with compressed air can remove interstitial fluid held in external voids in the sorbent material. When the sorbent material is saturated, this purge can remove any residual fluids to the feed line while leaving the adsorbed material within the sorbent material. When the sorbent bed finishes desorption, the purge can remove desorbent which can then be recycled to desorb other sorbent beds in the adsorption unit 240.

In such a manner, the first sorbent bed 410, the second sorbent bed 420, the third sorbent bed 430, and the fourth sorbent bed 440 can cycle between adsorption, a first purge, desorption, and a second purge. For example, as shown in FIG. 4B, the first sorbent bed 410 is undergoing adsorption, the second sorbent bed 420 is undergoing the first purge, the third sorbent bed 430 is undergoing desorption, and the fourth sorbent bed 440 is undergoing the second purge. Upon completion, the first sorbent bed 410 can transition to the first purge, the second sorbent bed 420 can transition to desorption, the third sorbent bed 430 can transition to the second purge, and the fourth sorbent bed 440 can return to adsorption. As would be appreciated, such an arrangement can provide for a continuous process with one sorbent bed undergoing adsorption; the adsorption unit 240 can continuously receive fluid from the feed line 210 and conduct adsorption in the adsorption unit 240.

As would be appreciated, each sorbent bed comprises an adsorbent material. The adsorbent material can be a zeolite comprising solid crystals having a size from 200 nm to 250 nm. For instance, the adsorbent material can be the zeolite ZSM-5 (MFI). The adsorbent material can also have material properties to encourage the adsorption of the biofuel precursor while rejecting the biomass byproduct and water. For instance, the adsorbent material can have an uptake from 80 g of a biofuel precursor/kg of zeolite to 95 g of biofuel precursor/kg of zeolite (e.g., from 81 to 95, from 82 to 95, from 83 to 95, from 84 to 95, from 85 to 95, from 86 to 95, from 87 to 95, from 88 to 95, from 89 to 95, from 90 to 95, from 81 to 94, from 82 to 93, from 83 to 92, from 84 to 91, or from 85 to 90). The adsorbent material can also have a biofuel precursor/water selectivity from 10 to 25 (e.g., from 11 to 25, from 12 to 25, from 13 to 25, from 14 to 25, from 15 to 25, from 16 to 25, from 17 to 25, from 18 to 25, from 19 to 25, from 20 to 25, from 11 to 24, from 12 to 23, from 13 to 22 from 14 to 21, or from 15 to 20).

Certain embodiments and implementations of the disclosed technology are described above with reference to block and flow diagrams of systems and methods according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

### EXAMPLES

The following sections illustrate example implementations of the present disclosure/disclosed technology:

An example implementation of the disclosed technology can demonstrate a selective enrichment and recovery of 2,3-BDO from a corn stover hydrolysate fermentation broth by a pure- silica nano-MFI-type zeolite adsorbent. The disclosed technology can employ means of cyclic and simulated moving bed adsorption processes to obtain concentrated aqueous 2,3-BDO streams from a fermentation process stream, which may have ˜93% purity and 3-fold enrichment, and >98% purity and 8-fold enrichment, respectively.

The example implementation can include a medium-pore (˜0.6 nm), hydrophobic, and chemically robust materials, such as zeolite, to provide 2,3_BDO adsorption selectivity, mass transfer (diffusion) characteristics, as well as chemical stability in the fermentation broth and desorbent. MFI type zeolites can be chosen as a potentially desirable adsorbent. MFI can be amenable to bulk synthesis, and its hydrophobicity can be controlled by adjusting the Si/Al ratio, for which a pure-SiO2 (hydrophobic) MFI would be most suitable. Furthermore, to provide favorable diffusion characteristics, nanosize (21 300 nm) MFI materials can be synthesized for fabrication of adsorbent pellets. The adsorption and separation behavior of the MFI adsorbent in the fermentation broth can be measured in detail, and excellent separation characteristics and long-term stability may be found. The recovery and purification of 2,3-BDO can be developed and experimentally demonstrated by a model-guided simulated moving bed (SMB) process that depicts the potential for industrial applications.

Materials: Chemicals used in the synthesis of pure silica MFI (sometimes referred to herein as GT-MFI) can include tetraethylorthosilicate (TEOS), and 1 M tetrapropylammonium hydroxide (TPAOH) solution in water. An industrial high silica ZSM-5 MFI (P-1500s, SiO2/Al2O3>1500) was purchased from ACS materials, which is named as cMFI in this work. Chemicals used to prepare model broth can include 2,3-butanediol (2,3-BDO mixture of racemic and meso forms), D(+)-glucose, D(+)-xylose, arabinose, malic acid, and xylitol. Lactic acid, acetic acid, glycerol, and ethanol can be included. Maltose can be used. The fermentation broth can be produced from corn stover hydrolysate according to a published method using the Z. mobilis strain at the National Renewable Energy Laboratory and can be received after removing cells and insoluble solids with 0.22 μm PES membrane.

Pure-Silica MFI Synthesis: 15 mL of 1 M TPAOH solution can be added to 12.05 g of DI water while stirring in a 60 mL polypropylene bottle. This can be followed by dropwise addition of 12.5 g of TEOS over the span of a few minutes while stirring at 600 rpm to obtain a gel composition of 1 TPAOH:4 TEOS:90 H2O. The cap for the polypropylene bottle can be closed, and the resultant solution can be aged at room temperature for 6 h while stirring at 600 rpm. The gel can be then transferred into a 40 mL Teflon-lined autoclave and placed into an oven preheated at 125° C. The hydrothermal treatment can be carried out for 24 h under static conditions in the oven. The oven can then be allowed to cool down on its own, and the autoclave can then be taken out to recover the MFI crystals. The MFI crystals can be recovered by centrifugation and washing with DI water 3 times at 8500 rpm for 15 min each. The solid product can then be dried in an oven at 75° C. for 6 h. This can be followed by calcination at 550° C. for 6 h with a ramp rate of 2° C./min (with both heating and cooling) to remove the organic template (TPAOH) and activate the zeolite.

Materials Characterization: Activated materials can be characterized by powder X-ray diffraction (PXRD), nitrogen physisorption, and scanning electron microscope (SEM). PXRD measurements can be performed on an X'Pert Pro PANalytical X-ray diffractometer in reflection (Bragg-Brentano) geometry operating with a Cu anode at 45 kV and 40 mA. PXRD patterns can be collected with a step size of 0.017 °2 θ and scan time of 10 s/step. Surface area and pore volume/size analyses can be estimated using nitrogen physisorption isotherms collected at 77 K using a BET surface area analyzer (BELSORP-max, Microtrac). SEM images were taken on a Hitachi SU8010.

Pelletization and Packed Column Preparation: The activated materials can be loaded into a pellet press die set. The adsorbent particles can be prepared without a binder. The pelletization condition can be 1000 psi for 60 s. The pellets can be ground into small particles, and can be sieved between 425 and 600 μm. A pressure higher than 1000 psi may lead to a significant loss of the pore volume. No breakdown of adsorbent may be observed through the entire work-frame. The particles can then be filled into stainless-steel columns (i.e., 0.94 mm ID×200 mm L). Both ends of the column can be fitted with frits to prevent the loss of adsorbent particles. For enhancing the mechanical strength of the adsorbent, Na2SiO3 as a binder can be incorporated into the MFI pellets. For example, 13.4 g of as-made pellets can be added into binder solutions with a concentration of 5.6 mg/L Na2SiO3 for 40 min while shaking at 100 rpm (New Brunswick Innova 2000) for good absorption of the binder material. Then, the solution can be removed, and the pellets can be dried at 70° C. overnight. Finally, the pellets can be calcined before being used for column packing.

Pretreatment of Fermentation Broth: Nanofiltration (NF) of the broth can be carried out in a Sterlitech high-pressure dead-end stirred cell (HP4750X). Ultrahigh purity nitrogen gas can supply the driving pressure with a transmembrane pressure (TMP) of 50 bar, which can be monitored by a pressure gauge. The NP010 membranes (Microdyn Nadir, molecular weight cutoff˜1 kDa) can be installed at the bottom of the stirred cell and can be supported by a stainless-steel mesh. The fermentation broth can be added into the feed chamber, and the whole system can be heated with heating tape and kept at 50° C. and monitored by a thermocouple. The NF permeate can be collected until an ˜50% volume reduction is reached. Neutral pH can facilitate the dissociation of the organic acids and reduce the uptake on MFI adsorbents. Therefore, the prefiltered broth (pH ≈5.6) can be neutralized to pH≈7 with 5 M sodium hydroxide solution before adsorption.

Model-Guided SMB Scale-Up Approach: This can be an adapted version from a previous methodology used to design SMB experiments for hydrocarbon mixtures. This can be a sequential approach, where the information obtained prior to any SMB run (Pre-SMB) can be used to design the first SMB experiment and beyond (SMB). The algorithm may assume limited initial knowledge, where only information regarding the feed composition, adsorbent material, and desorbent may be known. The result can be an accurately parametrized large-scale SMB that recovers 2,3-BDO and meets all performance requirements (productivity, purity, and recovery).

Pre-SMB Methods: Pre-SMB methods can include the following. Step 1: obtain an initial estimate of all physical parameters pertinent to the SMB. The isotherm parameters (qm, K and H) can be obtained from fitting the mixed linear +Langmuir (MLL) model to data from batch adsorption experiments of binary mixtures (2,3-BDO/water and ethanol/water). The mass transfer data (kapp and Pe) can be estimated from correlations found in the literature.

Step 2: After the experiments were conducted, the isotherm parameters can be refitted using new data. Breakthrough experiments can be used to calibrate the parameters. SMB Methods: The SMB methods can include the following. Step 3: The “Simultaneous Optimization and Model Correction” (SOMC) algorithm can be used to guide the design of SMB experiments. This may be an iterative approach, where the operating conditions (zone velocities and step time) of an experiment can be selected based on the optimization of the SMB model. The experiment can be conducted, and the parameters are tuned by fitting the model to the collected concentration data. Based on the updated parameters, a new set of operating conditions can be obtained, and the process can be iterated until the convergence criterion is met. At this point, only “small scale” (65 g of adsorbent) SMB experiments may be conducted, with a binary 2,3-BDO (10 wt %) and water as the feed and pure ethanol as the desorbent. Step 4: The SMB can be scaled to approximately seven times (˜520 g of adsorbent) the previous size. The operating conditions of this larger-scale system can be obtained by optimizing the model based on the converged set of parameters from the previous step. The minimum performance requirements of this system can be 0.20 kgBDO/day productivity at 70% desorbent-free purity and 95% recovery. The experiment can be conducted, and if the results match the model, the algorithm may be terminated. The feed to this SMB can be the real broth with ˜10 wt % 2,3-BDO. Pure ethanol can be used as the desorbent. Step 5: If the minimum performance requirements are not met, the model can be tuned based on the new experimental data, and the updated parameters can be used to repeat step 4.

Adsorption Breakthrough Measurements: The breakthrough experiments can be carried out using stainless-steel columns packed with the adsorbent at 303 K. Ethanol can be selected as the desorbent in this work due to its good miscibility with both 2,3-BDO and water and its low boiling point. Before the breakthrough measurements, the packed column can be regenerated with 0.2 mL/min ethanol under 303 K for 500 min. In the breakthrough measurements, the feed solution (model broth or real pretreated broth) can be introduced into the packed column using an HPLC pump (Shimadzu LC-20AD) at 0.2 mL/min. The outlet stream of the column can be collected periodically into 2 mL HPLC vials in the fraction collector (Shimadzu FRC-10R). These samples can be analyzed offline to obtain the points on the breakthrough curve at a specific time. The concentrations of sugars, alcohols, organic acids, and acetoin can be analyzed by HPLC. The concentration of water can be analyzed by GC. Due to the large molecule size and high hydrophilicity, maltose in the feed solution can be assumed as the nonadsorbing component (tracer) in the breakthrough experiments. The uptake of component i (qi, mg/g adsorbents) at a specific time t in the breakthrough measurements can be calculated by the following equation:

$${Q}_{i} = \frac{{C}_{i , 0} \dot{v}}{m} {\int }_{0}^{t} ( \frac{{C}_{maltose , out}}{{C}_{maltose , 0}} - \frac{{C}_{i , out}}{{C}_{i , 0}} ) dt$$

where m (g) is the loading of the adsorbents in the column; \dot{v} (mL/min) is the flow rate of the feed solution; C_{i,o} (g/L) is the concentration of component i in the feed stream and C_{i,out} (g/L) is the concentration in the outlet streams; the ratio of C_{maltose,out} (g/L) and C_{maltose,0} (g/L) is the normalized concentration of maltose in the outlet streams; t (min) is the duration of adsorption. Separation factors for pairs of components in the broth mixture can be calculated according to the equation:

$${S}_{i / j} = \frac{{Q}_{i}}{{Q}_{j}} / \frac{{C}_{i , feed}}{{C}_{j , feed}}$$

where Qᵢ and Qⱼ are the adsorbed amounts of component i and j (mg/g adsorbents), whereas C_{i,feed} and C_{j,feed} are the concentrations of component (or species) i and j in the feed stream (g/L).

Cyclic Column Operation: Cyclic operation (back-to-back production runs) can be performed on the GT-MFI column with three steps in each cycle. The first step can be adsorption with 0.2 ml/min real pretreated broth as the feed stream, and the outlet stream can be collected as BDO-free stream (raffinate). The adsorption can be stopped at the breakthrough point of 2,3-BDO. The second step can be the purge step to remove the liquid in the interstitial space between the adsorbent pellets. N2 can be applied as the purge gas from gas cylinder at 50 mL/min controlled by flow meter for 0.5 h. The outlet stream can be recycled, as the composition may be similar to the feed stream. The third step can be to desorb and regenerate the column with pure ethanol at a flow rate of 0.2 mL/min. In this step, the outlet stream collected can be regarded as the extract product. The outlet stream during adsorption and desorption can be collected periodically into the HPLC vials and analyzed offline. The purity (wt %) can be defined in an ethanol and water free basis according to the equation:

$${Purity}_{i} = \frac{\overline{{C}_{ι}}}{{\sum }_{j = 1}^{n} {C}_{j}} \times 100 ( \% )$$

where C̅ₗ is the average concentration (g/L) of component of interest (2,3-BDO in this work) and the sum at the denominator is the total average concentration of components other that water (i.e., sugars, organic acids, alcohols, and acetoin) in the stream. Recovery can be another important indicator to evaluate the efficiency of the adsorption process. The outlet stream during the purge step can be recycled. The extract collected during desorption can be the product stream, and the raffinate can be where the loss of BDO occurred. Therefore, the recovery of component i in the production run can be calculated according to the following equation:

$${Recovery}_{i} = ( 1 - \frac{{\dot{m}}_{i , raf}}{{\dot{m}}_{i , feed}} ) \times 100 ( \% )$$

where \dot{m}_{i,raf} and m_{i,feed} are the mass productivity rate (kg·hr−1·ton−1 MFI adsorbents) of component i in raffinate and feed, respectively. The component i can be 2,3-BDO. The productivity (g) of BDO during desorption can be calculated as:

$${\dot{m}}_{BDO} = 60 \times {\dot{v}}_{des} {\int }_{{t}_{0}}^{{t}_{1}} {C}_{BDO , out} d t$$

where \dot{v}_{des} (mL/min) is the flow rate of ethanol; C_{BDO,out} (g/L) is the concentration of BDO in the outlet stream; t₀ (min) is the time when the extract product collection starts, and t₁ (min) is the time when extract product collection ends.

Vacuum Distillation: Ethanol in the obtained BDO-rich extract streams from the desorption stage can be recovered by vacuum distillation with a rotatory evaporator (Across International SE05). The rotatory evaporator can be operated at 50° C. and 0.2 bar.

Batch Adsorption: To obtain estimates of the isotherm parameters, batch adsorption experiments can be conducted for 2,3-BDO/water and ethanol/water binary mixtures at 296 K. Approximately 0.3 mg of MFI zeolite pellet with the appropriate amount of solution can be added to a 20 mL glass vial. The solution volume to adsorbent mass ratios may vary from 13 to 16 mL/g. The vials can be shaken at 136 rpm on a digital platform shaker (New Brunswick Innova 2000) for 24 h at 296 K to ensure the adsorptions reached equilibrium. Then the supernatant solutions can be filtered and transferred to a 1.5 mL glass vial (Supelco) through a 1 mL tuberculin syringe (BD) with a 0.2 μm syringe filter (Shimadzu) for concentration analysis. The following mass balance expressions can be used to determine the adsorption uptake of each component.

$${V}_{in} {C}_{in , i} = {V}_{eq} {C}_{eq , i} + {m}_{MFI} {Q}_{e q , i}$$

where Cᵢ concentration of a component i in the solution in g/mL, Q_{eq,i} is the adsorption uptake in g/g_{MFI}, V is the volume of the solution in mL, and m_{MFI} is the mass of the MFI adsorbent in g. The subscripts in and eq denote the initial and equilibrium states, respectively. In practice, V_{eq} and Q_{eq,i} cannot be measured directly from experiments, yielding n+1 unknowns for n independent equations, where n is the number of components. Thus, an additional relation must be included to obtain a unique solution. Thr following expression can be used:

$${V}_{p} = \sum \frac{{Q}_{eq , i}}{{ρ}_{i}}$$

This can be denoted as the pore filling adsorption model, where the adsorbed solution can be assumed to behave like an ideal mixture and occupy a pore volume Vₚ (cm³/g_{MFI}). In the case of the proposed MFI, it can be assumed that Vₚ corresponds to the micropore volume of the adsorbent measured by physisorption (0.180 cm³/g_{MFI}) and that ρᵢ is the density of each component.

The collected batch adsorption data can be used to obtain isotherm parameters that can then be incorporated to a dynamic adsorption model. The MLL isotherm can be chosen for this system, where q_{m,i}, Kᵢ, and Hᵢ are the saturated capacity, Langmuir affinity constant, and Henry's linear constant of each component i at equilibrium, respectively.

$${Q}_{i} = {H}_{i} {c}_{i} + \frac{{q}_{m , i} {K}_{i}}{1 + \sum {K}_{i} {c}_{i}}$$

Liquid Sample Analysis: HPLC can be used to quantitatively analyze the sugars (i.e., maltose, xylose, and arabinose), alcohols (i.e., glycerol, xylitol, and 2,3-BDO), organic acids (i.e., malic acid, lactic acid, and acetic acid), and acetoin in the model solution and real pretreated broth. A Shimadzu HPLC system can be equipped with a Bio-Rad Aminex HPX87-H column (300 mm×7.8 mm i.d.) at 65° C. The mobile phase can be 5 mM H₂SO₄ in DI water at a flow rate of 0.5 mL/min. The column can be coupled to a refractive index detector. The sum concentration of arabinose and xylitol can be calculated due to peak overlapping. The concentration of organic acids may indicate the total concentration of their protonated forms and ionic pairs. Water can be quantified by GC equipped with a Phenomenex ZB-1 column and a thermal conductivity detector.

SMB Modeling: SMB can be modeled through the solution of a system of partial differential algebraic equations. The transport dispersive model can be implemented to describe the SMB, and a system of PDAEs can be fully discretized in time and space and solved simultaneously with appropriate cyclic-steady state (CSS) conditions. The result can be a nonlinear programming (NLP) problem, which can be built in Pyomo 6.6.2. and solved using IPOPT_sens 3.12.13.0. The following can be the SMB equations:

Mass transfer in the solid (adsorbent) phase:

$$\frac{\partial {q}_{i}^{k}}{\partial t} + {e}_{p} \frac{\partial {c}_{p , i}^{k}}{\partial t} = {k}_{app} ( {c}_{i}^{k} - {c}_{p , i}^{k} )$$

Mass transfer in the bulk liquid phase:

$$\frac{\partial {c}_{i}^{k}}{\partial t} + {u}^{k} \frac{\partial {c}_{i}^{k}}{\partial x} - {D}_{ax}^{k} \frac{\partial {c}_{i}^{k}}{\partial {x}^{2}} + \frac{1 - {e}_{b}}{{e}_{b}} {k}_{app} ( {c}_{i}^{k} - {c}_{p , i}^{k} ) = 0$$

Adsorption equilibrium:

qᵢ^{k}=f(c_{p,i}^{k})

where qᵢ is the concentration in the solid phase of the MFI adsorbent (g/cm³_{MFI,bulk}) and can be obtained by multiplying the adsorption uptake expression by the MFI adsorbent bulk density (qᵢ=Qᵢ*ρ_{MFI,bulk}). Furthermore, Cₚᵢ is concentration in the particle pores (g/cm³ ₛₒₗᵤₜᵢₒₙ), Cᵢ is the concentration of the bulk liquid (g/cm³ₛₒₗᵤₜᵢₒₙ), eₚ is porosity of adsorbent pellets, kₐₚₚ is apparent mass transfer coefficient (min−1), u is the superficial velocity (\dot{v}=u×area) (cm/min), Dₐₓ is the axial dispersion (cm²/min), and f is an adsorption isotherm expression that can be used to obtain the uptake (instantaneous equilibrium can be assumed). The subscript i can denote the components and the superscript k the SMB columns. As a simplification, the dead volume of the system can be represented by thin empty tubes positioned at the end of each adsorption bed column. The tubes can be identical in size and may be described by the following expression.

$$\frac{\partial {c}_{dv , i}^{k}}{\partial t} + {u}_{dv}^{k} \frac{\partial {c}_{dv , i}^{k}}{\partial x} - {D}_{ax , dv}^{k} \frac{{\partial }^{2} {c}_{dv , i}^{k}}{\partial {x}^{2}} = 0$$

Finally, the boundary and cyclic state conditions can be added to the model.

SMB Operation: A SMB “mini-plant” unit (CSEP C190, Knauer) can be used for experiments and production runs. The unit can be equipped with four-piston pumps for controlling the inlet and outlet liquid flow streams of the system. A UV detector can be connected to the outlet of the extract stream for online concentration monitoring. All eight adsorption columns (300 mm length and 20 mm inner diameter), each loaded with 65 g MFI adsorbent pellets (400-595 μm), can be connected to the ports of the rotary valve. Columns can be connected in series, with two columns in each zone to form a 4-zone SMB configuration (2-2-2-2). The SMB can operate in a counter-current flow pattern. The column movement can be simulated by the rotary valve which switches the columns' position relative to the inlet/outlet position per step time per column position. In this configuration, zone 2 and zone 3 can act as the separation zones, where the strongly adsorbed component can be selectively absorbed onto the adsorbent, while the weakly adsorbed components can be carried through. Separation performance metrics for SMB can be defined as follows:

$$Desorbent free ( D - free ) weight fraction = \frac{{c}_{i}}{\sum {c}_{i}} \times 100 \%$$

$$Extract recovery = 1 - \frac{{\dot{v}}_{raf} * {C}_{i , raf}}{{\dot{v}}_{feed} * {C}_{i , feed}} \times 100 \%$$

$$Production rate = {\dot{v}}_{ext} \times {C}_{BDO , ext}^{CSS}$$

Extract stream purity can be defined as D-free weight fraction for component i, hence ΣCᵢ can be concentration for all components excluding ethanol, \dot{v}_{raf} and \dot{v}_{feed} are the volumetric flow rate (mL/min) for raffinate stream and feed stream, C_{BDO,ext}^{CSS} can be the CSS average concentration (g/L) of 2,3-BDO in the extract stream.

Results and Discussion: The morphology of the synthesized pure-silica MFI (GT-MFI) nanocrystals can have a uniform pill-like shape and are ˜250 nm in diameter. The commercially available high-silica ZSM-5 (cMFI) can have a very different rod-like morphology, with lengths of 600-800 nm and thickness less than 100 nm. While powder XRD can show the presence of crystalline MFI-type zeolite in both materials, the physisorption isotherms can be different. Specifically, the BET surface area and micropore volume of GT-MFI can be considerably higher than those of cMFI.

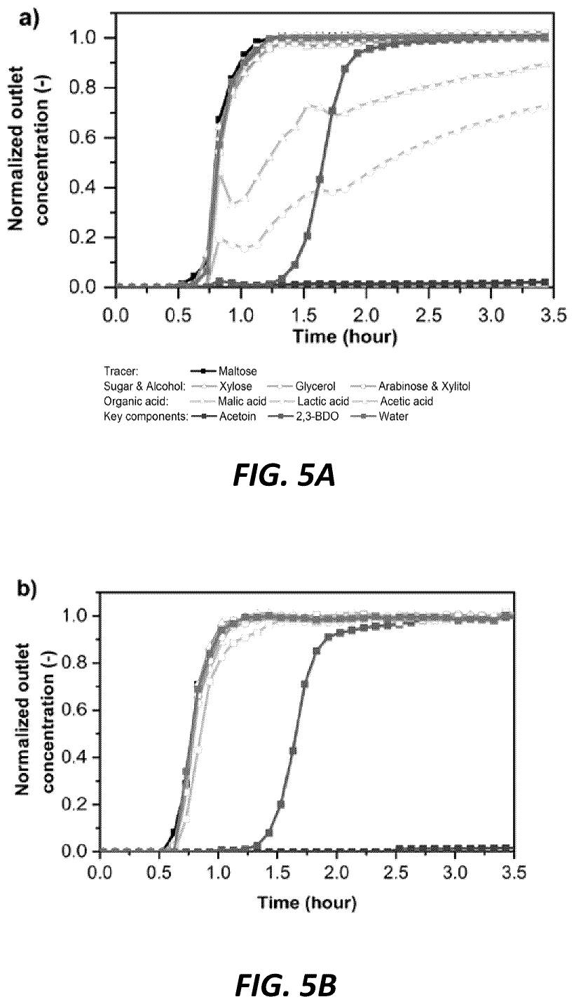

Due to the presence of organic acids in the fermentation product broth, it may be necessary to determine an appropriate pH to which the feed should be preadjusted before adsorptive separation. A model broth can be prepared by closely following the composition of the main components in the fermentation broth. Due to the organic acids, the pH of this model feed can be 2.4. A breakthrough measurement can be performed with this feed at 303 K using a pelletized GT-MFI adsorbent column (ID 0.94 cm, length 20 cm), the results of which are shown in FIG. 5A.

Maltose—a large disaccharide molecule, can be considered as the tracer species that can be assumed to be nonadsorbing in MFI. The sugars (xylose, arabinose), xylitol, glycerol, and water may break through quickly along with maltose; i.e., they may not be adsorbed due to their large molecular size and/or hydro-philicity. In contrast, 2,3-BDO and acetoin can show strong adsorption in GT-MFI, with acetoin still not having broken (due to its low concentration in the feed). Acetic, lactic, and malic acids may also be considerably adsorbed and may have not broken through fully. With dissociation constants (pKa) in the 3.8-5.2 range for these acids, they can exist substantially in protonated form at the feed pH of 2.4 and compete for adsorption sites with 2,3-BDO and acetoin. Therefore, the feed pH can be adjusted to neutral with the addition of sodium hydroxide, allowing organic acids to be deprotonated into their ionic forms. This can lead to a very sharp separation of 2,3-BDO and acetoin from all of the other components, as seen in FIG. 5B.

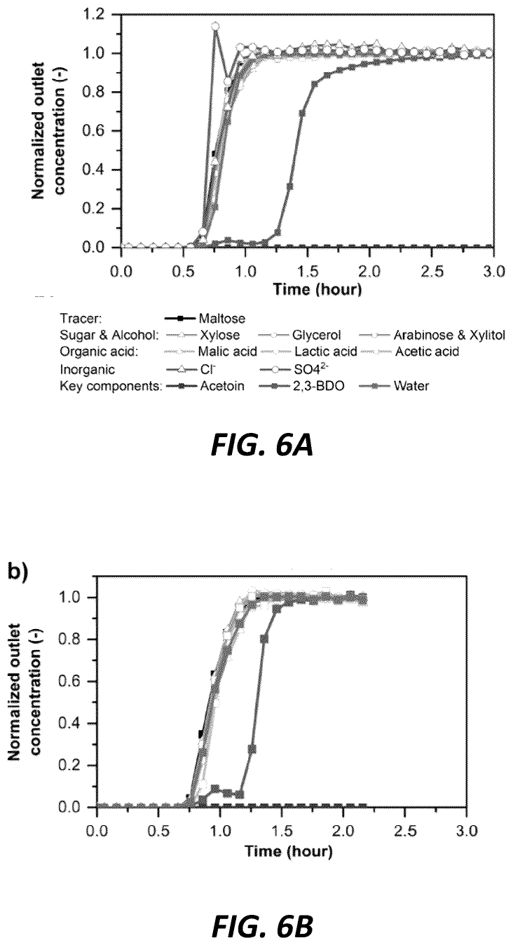

The separation characteristics of the pelletized GT-MFI and cMFI adsorbents can be then evaluated by breakthrough measurements on 20 cm-length packed columns at 303 K using the real pretreated fermentation broth. A very sharp separation of 2,3-BDO and acetoin from all other components may occur, including water, by the GT-MFI column, as seen in FIG. 6A. The “roll-up” like breakthrough behavior of the SO42-ion may be attributed to transient precipitation of inorganic salts due to low solubility in ethanol. Given the biomass-derived broth, cations such as Ca2+, Mg2+, Na+, and K+ can be expected to be present in small amounts. A weak initial plateau can be seen in the breakthrough curve of 2,3-BDO, which may likely be caused by a small amount of mesoporosity (or, alternatively, external surface sites) existing in the pelleted GT-MFI adsorbent. This can saturate faster than the microporosity due to the faster diffusion and uptake in these mesopores (or external surface sites).

The GT-MFI column can exhibit a high 2,3-BDO uptake capacity (93 g/kg) and excellent separation factors (11-38) for 2,3-BDO and acetoin over all other component types. Although the microporosity of pure silica GT-MFI adsorbent can be hydrophobic, there can still be a significant amount of water adsorbed due to its high chemical potential (concentration is 892 g/L) in the feed, large external surface area of the nanoparticle-based adsorbent, and possible coadsorption of water with 2,3-BDO in the micropores. These can be attributed to the presence of external silanol groups, whose concentration may increase with the external surface area as the primary particle size decreases. At the same time, faster mass transfer can be achieved with smaller primary particle sizes. GT-MFI can be synthesized with a primary particle size of <300 nm which provides good mass transfer, as indicated by the wider separation window, as shown in FIG. 6A, between 2,3-BDO and the other components compared to the cMFI adsorbent, as shown in FIG. 6B. This can be an example of the tradeoff between adsorbent hydrophobicity and faster mass transfer characteristics. The commercial material cMFI can also be able to separate 2,3-BDO and acetoin from the broth, but the 2,3-BDO uptake (about 69 g/kg zeolite) and separation factor can be considerably lower. Furthermore, another disadvantage of cMFI can be that 2,3-BDO experiences higher mass transfer resistance and breaks through faster than in GT-MFI. The tailored GT-MFI adsorbent can hence be the desirable candidate in terms of 2,3-BDO recovery and enrichment from fermentation broth.

Next, cyclic adsorption experiments can be performed to evaluate the production of an enriched 2,3-BDO product stream from pretreated broth using the GT-MFI column for two back-to-back production cycles. Each cycle can be divided into three steps (adsorption, purge, and desorption) and two cycles can be performed to evaluate the robustness of the GT-MFI column.

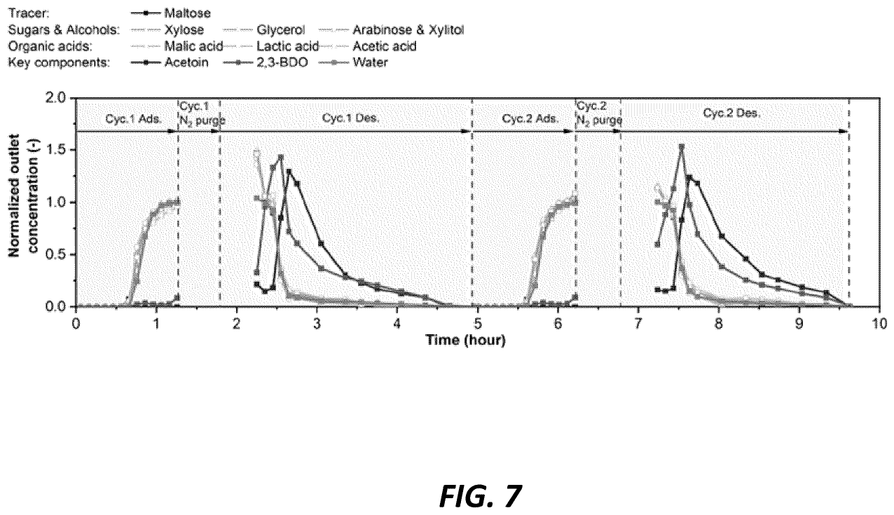

Considering the adsorption step, the breakthrough behavior can show that the breakthrough of most components can be at about 0.7 h, while the concentration of 2,3-BDO can increase sharply at about 1.3 h. To avoid significant loss of 2,3-BDO in the raffinate stream during adsorption, the pretreated broth feed can be stopped after 1.3 h. As can be seen in FIG. 7, the concentration profiles during the adsorption step can exhibit the same trends as those previously mentioned, and the uptake of each component during the adsorption in both cycles can be calculated. Because the equilibrium state may not be required in the dynamic production runs, the adsorption uptakes can be lower than those in the equilibrium breakthrough measurements. The purge step can start immediately after adsorption by switching the inlet stream to a N2 gas. By introducing a purge step before desorption, the quantity of the aqueous broth phase trapped in the interstitial porosity between the adsorbent pellets can be determined without desorbing the adsorbed phase in the zeolite micropores. The purge step may last for 0.5 h until no further aqueous liquid can be obtained at the column exit. Then the desorption step can be started by switching the inlet stream to cthanol. In the first 0.4 h of desorption, there may be no outlet stream, as ethanol can be filling the interstitial space. After this, the early stage of elution can be contaminated with residual interstitial aqueous phase. As ethanol continues to pass through the column, 2,3-BDO and acctoin can be increasingly displaced from the adsorbent, as indicated by the roll-up effect of the concentration profile of these two desired components. The desorption step can be continued until 2,3-BDO and acetoin are completely displaced by ethanol. The same patterns may be observed during both cycles, which can indicate the proposed cyclic operation is robust and reproducible.

Ideally, the extract phase can contain more than 60 wt % BDO considering the uptake on GT-MFI during the adsorption step, based on the data calculated from the cyclic production runs. The N2 purge step can remove much of the aqueous liquid in the interstitial space between adsorbent pellets but not the aqueous liquid present in the macro-/mesopores within the adsorbent pellets. The contamination of the extract by the aqueous phase can be seen in the early elution during desorption, wherein significant amounts of sugars, alcohols, acids, and especially water are present. Those concentration profiles may be even higher than those of 2,3-BDO at the early stage. Therefore, it can be possible to improve 2,3-BDO purity in the product stream by excluding early elution. The separation performance and product quality can be compared by starting the extract product collection at different times during the desorption step. The BDO purity, recovery, and productivity can be calculated as discussed previously herein. By starting extract product collection later in the desorption step, the 2,3-BDO content and purity can increase (due to lower contamination with the aqueous phase) whereas the 2,3-BDO productivity in the extract can decrease due to the increased loss of 2,3-BDO in the contaminated initial elution stage. Therefore, there can be a tradeoff between BDO purity and productivity. The total raffinate and extract collected from the two cycles can be combined and their composition analyzed after removal of the ethanol desorbent by vacuum evaporation (which can approximate a vacuum distillation column). The concentration of 2,3-BDO increased from 99 g/L (feed) to 328 g/L (extract), which indicates that 2,3-BDO can be enriched by about 3 times in the extract product stream. Furthermore, the gas purge step can be impractical in large-scale applications. Finally, the total desorbent-to-feed ratio in each cycle can be 3.34, which may require significant energy for ethanol desorbent recycling. As a result, a continuous countercurrent operation (which can be approximated by an SMB system) may be desirable to minimize the desorbent-to-feed ratio and increase the extract purity and 2,3-BDO recovery.

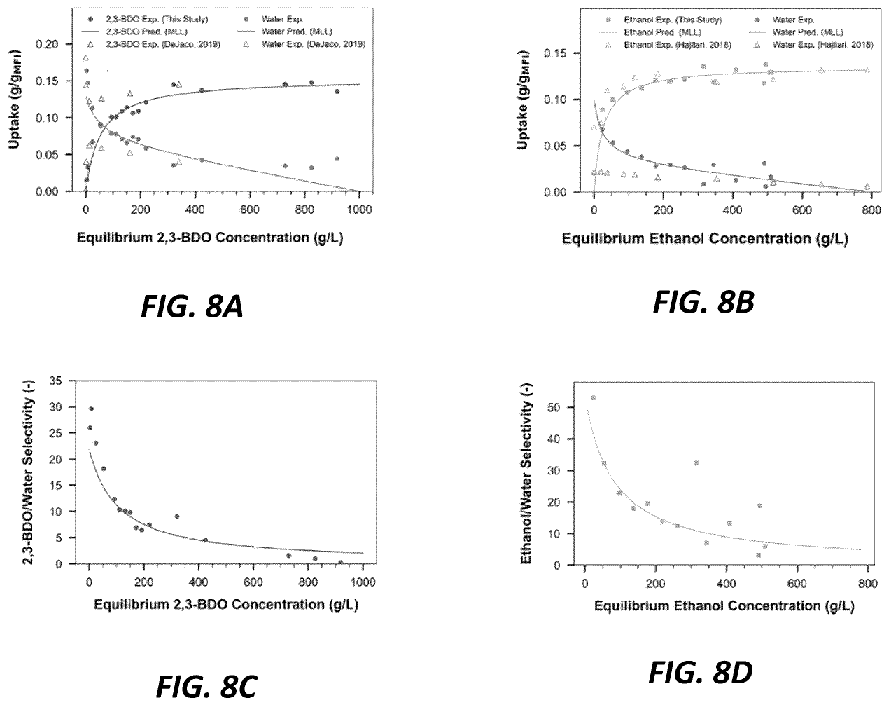

Model Based Approach Implementation for SMB: The proposed model-guided approach can be implemented to develop a predictive SMB model. Batch adsorption experiments can be conducted for 2,3-BDO/water and ethanol/water binary mixtures in GT-MFI at 296 K. This may be important for accurately predicting liquid and adsorbed phase compositions across four distinct zones and the column switching time. The obtained isotherms can have measured uptakes for 2,3-BDO and ethanol aligning with those reported for similar systems. The chosen MLL isotherm may accurately predict the uptake of these components. The adsorption uptakes of 2,3-BDO/water and cthanol/water mixtures over a range of concentrations are illustrated in FIGS. 8A and 8B, and the corresponding 2,3-BDO/water and ethanol/water separation factors are shown in FIGS. 8C and 8D. The behavior of both mixtures may be qualitatively similar. Ethanol may exhibit a higher affinity constant (74.3 mL/g) to GT-MFI compared to 2,3-BDO (57.8 mL/g) as well as a higher separation factor from water. These characteristics, along with its low boiling point, can make ethanol a suitable desorbent. The affinity constants for water in both mixtures can be very low (0.50 and 0.90 mL/g) due to the hydrophobic nature of the adsorbent, which can lead to high separation factors for the two alcohols over water. The selectivities for 2,3-BDO and ethanol over water can decline with increasing concentrations but remain >1 over most of the binary composition range. Next, the mass transfer parameters (Pe and kₐₚₚ) can be estimated based on correlations previously used for SMB systems on aqueous mixtures. The kₐₚₚ values can be well within the order magnitude reported by others for adsorption systems of miscible liquids and Pe can be further validated by fitting of a tracer breakthrough curve.

These parameters can be used to fit experimental breakthrough data for a 10 wt % 2,3-BDO feed at 303 K. Breakthrough times can be accurately predicted, and there can be good agreement from the model until the latter portion of the curve, where there may be salient deviations. While some discrepancy can be attributed to the stability and precision of the chosen numerical solver, there may be some aspects of the model (isotherm and mass transfer) that contribute to the deviation. First, the model may predict a roll-up effect that is not present in the experimental data, which can be the result of using a competitive Langmuir isotherm to describe the uptake. Second, the experimental breakthrough curve for 2,3-BDO may take longer than expected to reach the saturation plateau compared to water. Without wishing to be bound by any particular scientific theory, this trend can be attributed to the increased micropore transport resistance (i.e., slower diffusion) at higher 2,3-BDO loadings, thereby affecting the overall mass transfer of 2,3-BDO in the system. Without wishing to be bound by any particular scientific theory, this behavior that has been observed for methanol in MFI and has been attributed to hindered diffusion as the particle becomes increasingly saturated. This may be shown to decrease the methanol diffusivity by more than an order of magnitude. Despite the approximations of the present model, it may still able to predict the key features of the breakthrough curve. In addition, the concentration profiles observed in single adsorption columns may not expected to be like those in the SMB, and the deviations from the breakthrough curve may not significant enough to affect the applicability of the present model. The change in concentration (in both liquid and solid phases) observed in the breakthrough columns may not be the same as in the SMB, and more accurate results can be obtained by fitting the SMB data directly.

Next, the concurrent approach can be implemented. An SMB profile can be developed that optimizes productivity based on the available parameters. This profile may help to determine the composition of the ternary mixtures to be tested through batch experiments. After these experiments are conducted at 296 K, the MLL model can be refitted to the data and a new set of parameters can be obtained. The parameters can be calibrated more effectively by fitting the parameters to the SMB data directly.

SMB (Step 3): Based upon parameters previously discussed herein, the validation and parameter tuning can be conducted using a small-scale SMB equipped with eight 20 cm columns. The columns can be individually tested for adsorption performance by conducting model solution breakthrough experiments under preparative chromatographic flow rate (2 mL/min). To ensure smooth operation of the preparative SMB, the temperature can be increased from 303 to 323 K to reduce liquid density and viscosity to prevent high pressure drop in the columns. Consistent adsorption performance can occur among the columns, with a BDO uptake of 88 35 3 mg/g of MFI and a BDO/H2O selectivity of 19±5. Then, the eight columns can be installed in the SMB unit for iterative process modeling and prediction. Four SMB experiments can be conducted, with model solution as feed and ethanol as desorbent. An adapted version of the SOMC algorithm can be employed to design the SMB experiments at 323 K. The converged parameters after four iterations can be determined. There may be a deviation from these values, with respect to the pre-SMB estimates. Some of this discrepancy may be expected, considering that temperature from the batch and SMB experiments can be different and that the chosen mass transfer correlations can only provide an order of magnitude estimate. In addition, large uncertainty in the uptake calculations of the batch experiments can also contribute to this deviation from the initial guess. Nevertheless, the converged parameters may still be within a reasonable range.

The average (c̅(x, t)=∫₀^{tstep}c(x, t)dt) SMB internal concentration profile predictions at CSS can be determined for the four runs, along with the experimental compositions at the desorbent (D), extract (E), feed (F), and raffinate (R) locations. The profile predictions can closely match the experiments at these key locations. This can lead to accurate predictions of the main SMB performance parameters (productivity, purity, and recovery). As has been shown by others, ill-conditioning may be unavoidable for highly nonlinear adsorption systems. This may make the parameters highly correlated and practically unidentifiable. Regularization can be commonly used in these situations.

SMB Scale-Up (Steps 4 and 5): Having established an initial SMB model and predictions for further scale-up, the SMB system can be modified to validate the predictions. The SMB unit can be scaled by replacing the eight 20 cm columns with eight larger columns of 30 cm length and 2.1 cm ID, each filled with 65 g of adsorbent pellets, i.e., about 7.5 times higher adsorbent volume. The pellets used in these larger columns may have a small amount (1.5-2 wt % of total pellet mass) of sodium silicate binder for increased mechanical strength to withstand the much higher flow rates. The binder can be added to the prefabricated pellets. The 2,3-BDO uptake may remain essentially identical, whereas the 2,3-BDO/water separation factor can be somewhat lower after binder addition, likely due to the hydrophilic nature of the sodium silicate binder. However, the average separation factor may remain well above 10. Therefore, the physical parameters can be used to solve the large-scale SMB model. For water, 2,3-BDO, and ethanol, the isotherm and mass transfer parameters obtained from the convergence of the small-scale SMB experiments can be used. For acetoin, the same isotherm and mass transfer parameters of 2,3-BDO can be used, given their resemblance. For sugars, given their low concentration, the negligible values for the Langmuir terms (qₘ and K≈1×10⁻⁵) can be assumed and a Henry's constant of 0.10. The inorganics can be treated as nonadsorbing components, and all isotherm parameters can be set to very small (˜1×10⁻⁵) values. The remaining components (acids, xylitol, and glycerol) can be treated as weakly adsorbed, and the same parameters of water can be used. The apparent mass transfer coefficients of all the weak and nonadsorbing components can be assumed to be the same as water.

Two test SMB runs can be performed: the first can use a 10 wt % 2,3-BDO model feed whereas the second can use the model broth. Both runs may use the same set of operating conditions derived from the tuned SMB model, which may predict an extract with 77 wt % 2,3-BDO (desorbent-free basis), 98% recovery of 2,3-BDO in the extract, and a 2,3-BDO productivity of 0.345 kg/day in the extract stream. CSS can be reached by cycle 9 wherein the extract composition may become constant. The extract stream composition can reach 71 wt % 2,3-BDO with a nearly 100% recovery of 2,3-BDO from the feed stream. After the CSS is reached, the productivity can be 0.35 kg/day. Additionally, the other components in the model broth do not influence the enrichment and recovery of 2,3-BDO. Results can indicate that the model can accurately predict the SMB separation performance after increasing the scale.

SMB Production Run: A production run can be performed by feeding the pretreated fermentation process stream into the SMB. CSS can be reached at cycle 4 with the extract stream reaching 80 wt % 2,3-BDO, the recovery of 2,3-BDO reaching nearly 100%, and productivity of 0.35 kg/day of highly concentrated 2,3-BDO (corresponding to a 2,3-BDO production rate of 28 kg/ton MFI/h). The cumulative extract product collected after the process that reached CSS (i.e., cycle 4 onward) can be analyzed after removing ethanol desorbent by vacuum evaporation. The final 2,3-BDO concentration can be 816 g/L, which can be an 8-fold enrichment from the fermentation broth, with >98% purity. The concentrations of the other components can be considerably decreased in the final product relative to those of the feed, due to their very low recoveries in the extract. A second production run can be performed after regenerating the columns with the desorbent overnight at 2 mL/min. The same pretreated fermentation process stream can be used as a feed. The concentration profiles for 2,3-BDO, acetoin, and water in the extract stream may be nearly identical, hence the separation performance of the adsorbent can remain intact. The engineered MFI adsorbent may not only provide excellent separation performance but also mechanical and chemical robustness for realistic separations.

Conclusions: Preliminary breakthrough experiments using model broth with different pH values can indicate that neutralization of the broth can deprotonate the organic acids (byproduct during fermentation), which can facilitate their removal from 2,3-BDO through adsorption. Detailed column breakthrough experiments using both industrial MFI zeolite (aluminosilicate) and lab-scale synthesized pure silica MFI zeolite can show that synthesized MFI can provide higher BDO uptake, better BDO selectivities, and faster diffusion due to higher surface area and more uniform crystallization. The loading of 2,3-BDO from a pretreated fermentation broth (after filtration and neutralization) on the pure silica MFI zeolite can reach up to ˜93 g/kg of adsorbent. Detailed adsorption-desorption cycling of the MFI column can show robust with the pretreated fermentation stream. A concentrated aqueous 2,3-BDO product stream with 95% recovery, 93% purity, and 3-fold enrichment can be achieved with a single column. On the other hand, a model-guided continuous adsorption (SMB) approach can yield a concentrated aqueous 2,3-BDO product stream with nearly 100% recovery, 80 wt % 2,3-BDO, and 8-fold enrichment. While cyclic adsorption may offer simplicity in operation without requiring a robust mathematical model, SMB outperforms cyclic adsorption in terms of separation performance and can emerge as a viable and scalable approach for the recovery and enrichment of 2,3-BDO.

The following supplemental data may be considered.

The separation system can result in large energy savings by removing the massive parasitic cost/deadload of aqueous-phase BDO upgrading. The downstream BDO oligomerization reactor system can be reduced ˜10× in size and furthermore can be intensified in conversion rate and operating conditions based at least in part on the use of highly enriched BDO instead of aqueous BDO.

A novel BDO separation system components (adsorption unit and membrane pervaporation unit) can TRL 4 through bench-scale R&D using real BDO fermentation broths. Production rates of enriched (85+wt %) BDO relevant to the bench-scale can be in the 0.01 to 0.1 kg/day range, and may have run time scales of 10-30 hours.

An advanced separation process can be after a filtration step. The process can cleanly separate the organics from water (including the inorganic salts) early in the sequence, which may alleviate concern regarding catalyst degradation downstream. As a result, the baseline proposed separation process can have the ion exchanger be removed. Additionally, the dehydration reactor can be reduced in size (at least 10×) based at least in part on a lack of water deadload, and the downstream distillation column can be replaced with a simple phase separation tank to remove residual water from the hydrocarbons.

A baseline proposed separation system can include a BDO-selective cyclic adsorption system with four adsorbent columns and two distillation columns for ethanol desorbent recycle. Embodiments of the baseline separation system will be described in greater detail herein.

The baseline separation system can include three-unit operations: cyclic adsorption with 4 parallel columns to generate BDO-rich extract and aqueous raffinate streams, extract distillation to generate enriched BDO, and recycle ethanol (EtOH) desorbent to the adsorber, and raffinate distillation to recover some residual EtOH desorbent from the raffinate before it goes to wastewater treatment (WWT). In some embodiments, the baseline separation system can be at a same full commercial scale as a 2018 NREL SOT, which may correspond to a mass flow rate (MFR) of 205,917 kg/hr feed broth (containing 19,604 kg/hr BDO). For proposed pilot systems of the present disclosure (small pilot capable of 0.1-1 kg/day and large pilot capable of 1-10 kg/day production), the mass and energy balances can be linearly scaled from the full commercial scale tables.

General assumptions of the baseline separation system can include the following: the operation may include four beds operated at the same time in staggered cycling to simulate continuous work production; compressed air can be used to purge interstitial fluid held in an external void inside the absorption bed; ethanol can be desorbent; and stainless steel 304 can be used to manufacture the vessels and/or the units for cost analysis.

The unit operation of the baseline separation system can be described at a same commercial scale as the 2018 SOT to enable comparison. This may include a mass flow rate of 205,917 kg/hr feed broth (containing 19,604 kg/hr BDO). Proposed examples of the baseline separation system (small pilot at 0.1-1 kg/day feed rates and large pilot at 1-10 kg/day feed rates), the mass and energy balances can be linearly scaled.

The baseline separation system can have the following heat and material balance. The feed composition can be based on analysis of post-filtration broth mixtures. The feed MFR can be scaled with BDO MFR, 19604 kg/hr. The extract composition can be based on the analysis of lab-scale experiments. Ethanol concentration can be reduced assuming the concentration can be achieved when the operation is optimized. The extract MFR can be based at least in part on assuming the optimized operation is achieved by changing the aspect ratio of column to 1:3 (ID:L) to allow more efficient desorbing step. The raffinate composition and MFR can be a result of mass balance (Fixed feed, extract, desorbent MFR). A desorbent composition and MFR can be based on the simulated desorbent recovery results.

TABLE I
Mass Balance Data

| | Feed: | | Extract | | Raffinate | | Desorbent | |
|---|---|---|---|---|---|---|---|---|
| | to ADS | | to E-VC-DIS | | to R-DIS | | to ADS | |
| | Conc. | MFR | Conc. | MFR | Conc. | MFR | Conc. | MER |
| Stream | (wt %) | (kg/hr) | (wt %) | (kg/hr) | (wt %) | (kg/hr) | (wt %) | (kg/hr) |
| Xylose | 0.23 | 474 | 0.06 | 58 | 0.22 | 415 | 0 | 0 |
| Arabinose | 0.75 | 1544 | 0.19 | 204 | 0.71 | 1340 | 0 | 0 |
| Maltose | 1.27 | 2615 | 0.08 | 88 | 1.33 | 2528 | 0 | 0 |
| Xylitol | 0.29 | 597 | 0.11 | 117 | 0.25 | 480 | 0 | 0 |
| Glycerol | 0.63 | 1297 | 0.19 | 204 | 0.58 | 1093 | 0 | 0 |
| Acetic acid | 0.18 | 371 | 0.06 | 58 | 0.16 | 317 | 0 | 0 |
| Malic acid | 0.25 | 515 | 0.06 | 58 | 0.24 | 456 | 0 | 0 |
| Lactic acid | 0.3 | 618 | 0.08 | 88 | 0.28 | 530 | 0 | 0 |
| Na₃SO₄ | 0.28 | 529 | 0.00 | 0 | 0.28 | 529 | 0 | 0 |
| Acetoin | 0.17 | 350 | 0.33 | 350 | 0.00 | 0 | 0 | 0 |
| BDO | 9.52 | 19604 | 18.21 | 19212 | 0.21 | 392 | 0 | 0 |
| Water | 86.15 | 177410 | 7.20 | 7595 | 93.83 | 177837 | 10 | 8965 |
| Ethanol | 0 | 0 | 73.43 | 77477 | 1.91 | 3626 | 90 | 81103 |
| Total | 100 | 205917 | 100 | 105508 | 100 | 189540 | 100 | 90088 |

The mass balance shown above in Table I can be based upon adsorption and selectivity parameters from actual experimental data on bench-scale columns. There is no significant heat input in the adsorption unit operation. Adiabatic operation may be typical.

The processing conditions of the baseline separation system can be: temperature 30° C., and pressure 1 atm. The bare adsorption columns can be made of SS 304 (standard construction). The adsorbent can be a high-silica (SiO2) nanoporous zeolite MFI material which may have high selectivity for BDO. A 5-year service life of the MFI adsorbent material may be assumed. The mass balance may reflect data obtained from operation in real BDO broths obtained from NREL. Chemically analyzed contaminants may be included. All streams may be liquid at Temperature 30° C., Pressure 1 atm and according to the other operation parameters in Table II. The experimental data can be collected for a cyclic (unsteady state) process with temporally separated adsorption, air purge, and desorption steps within one cycle. The other process option (steady state SMB continuous) can be operated and modeled.

TABLE II
Operation Parameters and Conditions
Operation parameters and conditions

| Column # | 4 | |
|---|---|---|
| Temperature | 303 | K. |
| Maximum Pressure Drop | 2.14 | bar |
| Column ID/L (m) | 4.7/14.0 | |
| MFI loading (ton) per column | 160.3 | |
| Porosity | 0.445 | |
| (external void) | | |
| Time per cycle | 1.4 | hr |

What is claimed is:

1. An adsorption process comprising:
receiving a feed stream comprising a biofuel precursor in an amount from 5% to 15% by weight based on the total weight of the feed stream, a biomass byproduct, and water;
adsorbing, into a sorbent bed, the biofuel precursor, to form a raffinate stream comprising the biomass byproduct and water; and
desorbing the biofuel precursor from the sorbent bed to form an extract stream comprising the biofuel precursor.

2. The adsorption process of claim 1, wherein the biofuel precursor comprises 2,3-butanediol.

3. The adsorption process of claim 1, wherein the biomass byproduct comprises one or more of:
a sugar feedstock provided for a fermentation process of the biofuel precursor, a fermentation byproduct produced by the fermentation process of the biofuel precursor, and solid debris from the fermentation process of the biofuel precursor.

4. The adsorption process of claim 1, wherein the sorbent bed comprises a zeolite.

5. The adsorption process of claim 4, wherein the zeolite comprises the zeolite ZSM-5 (MFI).

6. The adsorption process of claim 4, wherein the zeolite comprises solid crystals having a size from 200 nm to 250 nm.

7. The adsorption process of claim 4, wherein the zeolite has an uptake from 80 g of biofuel precursor/kg of zeolite to 95 g of biofuel precursor/kg of zeolite.

8. The adsorption process of claim 4, wherein the zeolite has a biofuel precursor/water selectivity from 10 to 25.

9. The adsorption process of claim 1, wherein the sorbent bed is a first sorbent bed, and the adsorption process further comprises:
simultaneously desorbing the biofuel precursor from a second sorbent bed concurrently with the adsorbing the biofuel precursor into the first sorbent bed, the biofuel precursor from the second sorbent bed being transferred to extract stream; and
simultaneously adsorbing the biofuel precursor into the second sorbent bed concurrently with the desorbing the biofuel precursor from the first sorbent bed.

10. An adsorption system comprising:
a feed line configured to provide a feed stream comprising a biofuel precursor in an amount from 5% to 15% by weight based on the total weight of the feed stream, a biomass byproduct, and water;
a first sorbent bed attached to the feed line, the first sorbent bed configured to adsorb the biofuel precursor;
a second sorbent bed attached to the feed line, the second sorbent bed configured to adsorb the biofuel precursor;
a raffinate line attached to both the first sorbent bed and the second sorbent bed, the raffinate line receiving a raffinate stream from the first sorbent bed and the second sorbent bed, the raffinate stream comprising the biomass byproduct and water; and
an extract line attached to both the first sorbent bed and the second sorbent bed, the extract line receiving an extract stream from the first sorbent bed and the second sorbent bed, the extract stream comprising the biofuel precursor.

11. The adsorption system of claim 10, wherein the biofuel precursor comprises 2,3-butanediol.

12. The adsorption system of claim 10, wherein the biomass byproduct comprises one or more of: a sugar feedstock provided for a fermentation process of the biofuel precursor, a fermentation byproduct produced by the fermentation process of the biofuel precursor, and solid debris from the fermentation process of the biofuel precursor.

13. The adsorption system of claim 10, wherein the sorbent bed comprises a zeolite.

14. The adsorption system of claim 13, wherein the zeolite comprises the zeolite ZSM-5 (MFI).

15. The adsorption system of claim 13, wherein the zeolite comprises solid crystals having a size from 200 nm to 250 nm.

16. The adsorption system of claim 13, wherein the zeolite has an uptake from 80 g of biofuel precursor/kg of zeolite to 95 g of biofuel precursor/kg of zeolite.

17. The adsorption system of claim 13, wherein the zeolite has a biofuel precursor/water selectivity from 10 to 25.

18. An adsorbent material comprising:
a zeolite comprising solid crystals having a size from 200 nm to 250 nm, the zeolite having:
(i) an uptake from 80 g of a biofuel precursor/kg of zeolite to 95 g of biofuel precursor/kg of zeolite; and
(ii) a biofuel precursor/water selectivity from 10 to 25.

19. The adsorbent material of claim 18, wherein the biofuel precursor comprises 2,3-butanediol.

20. The adsorbent material of claim 18, wherein the zeolite comprises the zeolite ZSM-5 (MFI).
